(19) United States
(12) Patent Application Publication
(10) Pub. No.: US 2010/0036030 A1
(43) Pub. Date: Feb. 11, 2010

(54) Acrylic Resin Composition

(75) Inventors: Renee Josie Gide van Schijndel, Wageningen (NL); Jeffrey Thomas Carter, Cleveland (GB)

Correspondence Address: JONES DAY, 222 EAST 41ST ST, NEW YORK, NY, 10017, US

(73) Assignee: Croda International PLC, Goole, North Humberside (GB)

(21) Appl. No.: 12/084,028

(22) PCT Filed: Oct. 25, 2006
(86) PCT No.: PCT/GB2006/003965

§ 371 Date: Oct. 13, 2009

(51) Int. Cl. C09J 133/08; C08K 5/09; C08K 5/05; C08K 5/10

(52) U.S. Cl. 524/315; 524/300; 524/388

(57) ABSTRACT

A composition contains an acrylic resin and an impact modifier containing at least one dimer fatty acid and/or dimer fatty diol. The composition is suitable for use to form a sheet or as an adhesive, particularly as a pressure sensitive adhesive, anaerobic adhesive and a reactive hot-melt adhesive.

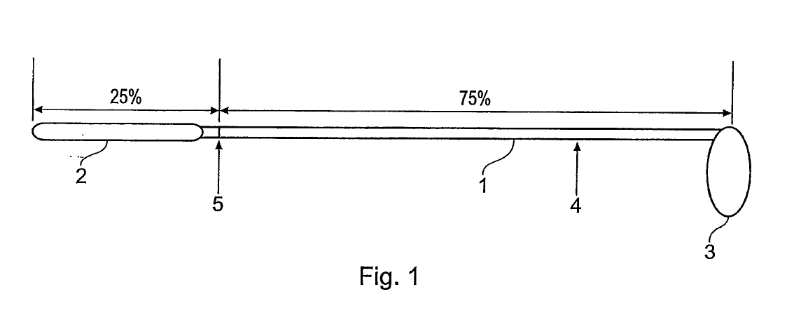

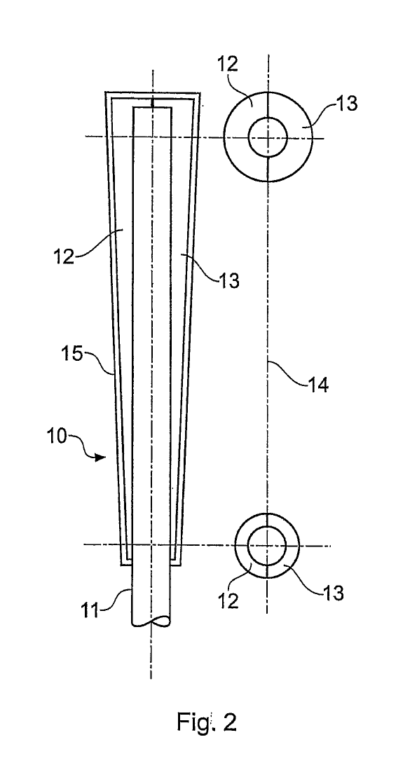

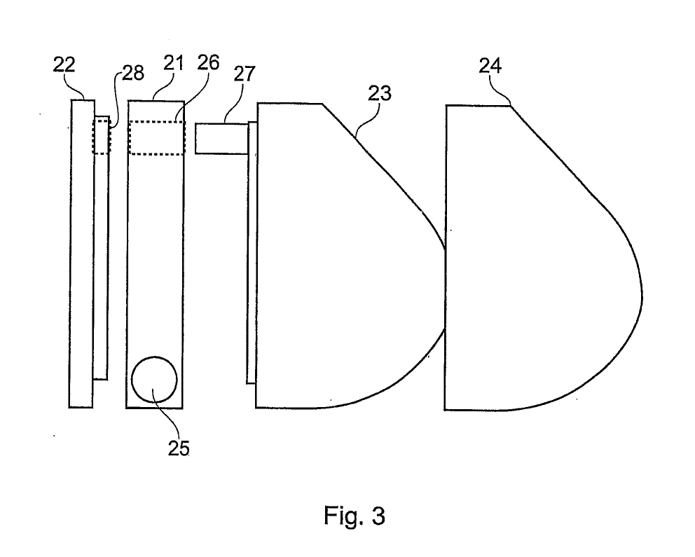

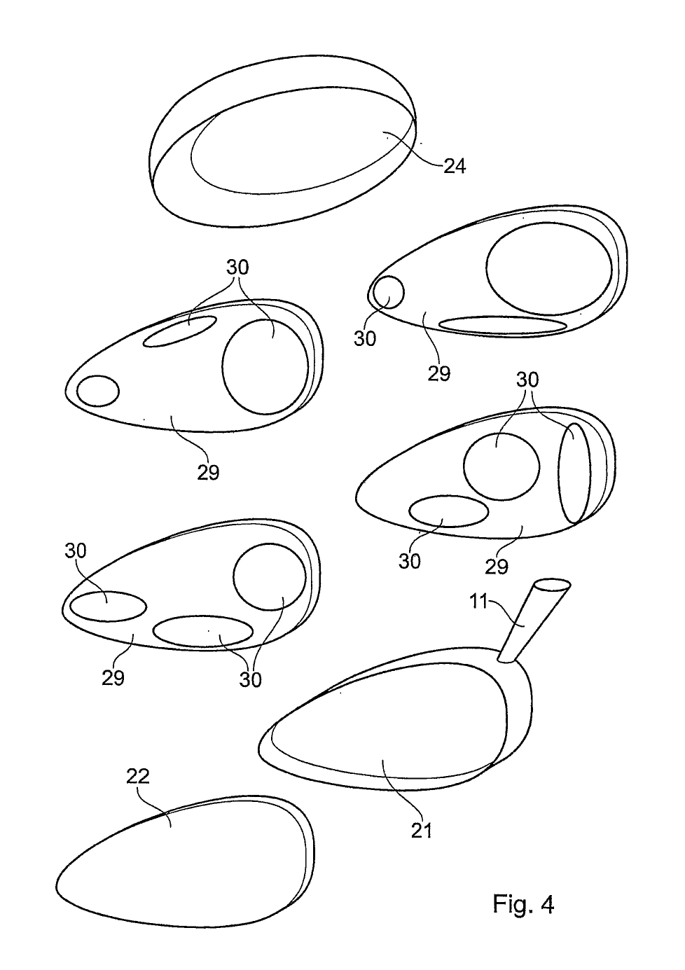

### FIELD OF INVENTION

The present invention relates to a composition comprising an acrylic resin and an Impact modifier, and in particular to the use thereof. In the form of a sheet or as an adhesive.

### BACKGROUND

Although acrylic based polymers have been used in a wide range of applications, their direct use as structural materials, coatings and adhesives has been limited due to their low impact resistance.

However, incorporating rubber elastomers or impact modifiers into the acrylic polymer matrix has been shown to increase the mechanical performance of the polymers. In particular, the introduction of core-shell materials has been used to produce toughened acrylic polymers. In this type of polymer blend, the load is borne by the glassy portion of its structure and the fracture energy is absorbed and dissipated in the dispersed rubbery phase which crazes and distorts during the dissipation of energy. Additional technologies have also been employed to develop toughened acrylic polymers. These systems utilise the phase separation phenomenon to produce rubber reinforced acrylic networks. This method has been shown to offer enhanced properties over the traditional core-shells, especially since they can be made to covalently graft into the acrylic phase.

Unfortunately, the components of synthetic rubbers can be toxic, and it is preferred not to use these materials for environmental reasons. The synthetic rubbers also have high a viscosity which can lead to difficulties in handling and moulding of acrylic resin. In addition, moisture uptake of an acrylic resin containing synthetic rubber can be a problem which can lead to thermal instability. Such materials can also suffer from ionic contamination by alkali metal and chloride ions which can result in corrosion, for example when the acrylic resin is used in electrical components. Generally, there is a requirement for acrylic resins to exhibit enhanced toughness, flexibility and/or moisture-resistance.

### SUMMARY OF THE INVENTION

We have now surprisingly discovered an acrylic resin composition which reduces or substantially overcomes at least one of the aforementioned problems.

Accordingly, the present invention provides a composition comprising an acrylic resin and an impact modifier comprising at least one dimer fatty acid and/or dimer fatty diol.

The invention also provides an adhesive comprising an acrylic resin and an impact modifier comprising at least one dimer fatty acid and/or dimer fatty diol.

The invention further provides the use of a composition comprising an acrylic resin and an impact modifier comprising at least one dimer fatty acid and/or dimer fatty diol as an adhesive.

The invention yet further provides a sheet comprising an acrylic resin and an impact modifier comprising at least one dimer fatty acid and/or dimer fatty diol.

The acrylic resin is preferably a composition comprising one or more acrylic monomers. Suitable acrylic monomers include acrylic acid and/or methacrylic acid, and/or esters thereof, especially an alkyl ester wherein the alkyl group contains up to ten, more preferably up to 6, carbon atoms such as methyl, ethyl, n-propyl, isopropyl, n-butyl, isobutyl, terbutyl, hexyl, 2-ethyl, hexyl, heptyl, and n-octyl. In a particularly preferred embodiment, mixtures of any two or more of the aforementioned monomers are employed. Preferred mixtures include an alkyl acrylate, preferably ethyl acrylate and/or butyl acrylate, together with an alkyl methacrylate, preferably methyl methacrylate. The acrylate monomer, preferably alkyl acrylate, is present in the range from 0 to 100, more preferably 10 to 90, particularly 20 to 80, and especially 30 to 70 mole %. Similarly, the methacrylate monomer, preferably alkyl methacrylate, is present in the range from 0 to 100, more preferably 10 to 90, particularly 20 to 80, and especially 30 to 70 mole %. The amount of methacrylate monomer present preferably exceeds the amount of acrylate monomer generally by an amount greater than 10, more preferably greater than 15, and especially greater than 20 mole %.

The acrylic resin may also comprise other, preferably optional, monomers, more preferably in addition to the aforementioned acrylic acid or methacrylic acid or esters thereof. Suitable materials include acrylonitrile, methacrylonitrile, halo-substituted acrylonitrile, halo-substituted methacrylonitrile, acrylamide, methacrylamide, N-methylol acrylamide, N-ethanol acrylamide, N-propanol acrylamide, N-methylol methacrylamide, N-ethanol methacrylamide, N-methyl acrylamide, N-tertiary butyl acrylamide, hydroxyethyl methacrylate, glycidyl acrylate, glycidyl methacrylate, dimethylamino ethyl methacrylate, itaconic acid, itaconic anhydride and half esters of itaconic acid.

Other, preferably optional, monomers include vinyl esters such as vinyl acetate, vinyl chloroacetate and vinyl benzoate; vinyl pyridine; vinyl chloride; vinylidene chloride; maleic acid; maleic anhydride; butadiene; styrene and derivatives of styrene such as chloro styrene, hydroxy styrene and alkylated styrenes wherein the alkyl group contains from one to ten carbon atoms.

The acrylic resin may be a homo- or co-oligomer or a homopolymer or copolymer, or mixture thereof, formed from at least one acrylate monomer.

Polymethyl methacrylate is preferred for forming a sheet, especially a thermoplastic sheet, and particularly in the form of a cast sheet. The sheet preferably has a thickness in the range from 6.1 to 100 mm, more preferably 1 to 20 mm, particularly 2 to 10 mm, and especially 3 to 7 mm.

For adhesive applications, the oligomeric or polymeric acrylic resins employed preferably have a molecular weight (number average) in the range from 500 to 200,000, more preferably 2,000 to 50,000, particularly 5,000 to 25,000, and especially 8,000 to 15,000.

For sheet applications, the polymeric acrylic resins employed preferably have a molecular weight (number average) in the range from 5,000 to 500,000 more preferably 10,000 to 100,000, particularly 20,000 to 50,000, and especially 30,000 to 40,000.

The impact modifier used in the present invention comprises and/or is formed from at least one dimer fatty acid and/or dimer fatty diol and/or equivalent thereof. The term dimer fatty acid is well known in the art and refers to the dimerisation product of mono- or polyunsaturated fatty acids and/or esters thereof. Preferred dimer fatty acids are dimers of C₁₀ to C₃₀, more preferably C₁₂ to C₂₄, particularly C₁₄ to C₂₂, and especially C₁₈ alkyl chains. Suitable dimer fatty acids include the dimerisation products of oleic acid, linoleic acid, linolenic acid, palmitoleic acid, and elaidic acid. The dimerisation products of the unsaturated fatty acid mixtures obtained in the hydrolysis of natural fats and oils, e.g. sunflower oil, soybean oil, olive oil, rapeseed oil, cottonseed oil and tall oil, may also be used. Hydrogenated, for example by using a nickel catalyst, dimer fatty acids may also be employed.

In addition to the dimer fatty acids, dimerisation usually results in varying amounts of oligomeric fatty acids (so-called “trimer”) and residues of monomeric fatty acids (so-called “monomer”), or esters thereof, being present. The amount of monomer can, for example, be reduced by distillation. Particularly preferred dimer fatty acids used in the present invention, have a dicarboxylic (or dimer) content of greater than 50%, more preferably greater than 70%, particularly greater than 85%, and especially greater than 94% by weight. The trimer content is preferably less than 50%, more preferably in the range from 1 to 20%, particularly 2 to 10%, and especially 3 to 6% by weight. The monomer content is preferably less than 5%, more preferably in the range from 0.1 to 3%, particularly 0.3 to 2%, and especially 0.5 to 1% by weight.

Dimer fatty diols can be produced by hydrogenation of the corresponding dimer fatty acid. The same preferences above for the dimer fatty acid apply to the corresponding dimer fatty diol component of the impact modifier.

The impact modifier is preferably an oligomer or polymer (hereinafter referred to as a polymer) formed from, is comprises reaction residues of, at least one dimer fatty acid and/or dimer fatty diol and/or equivalent thereof. Suitable polymers include polyesters, polyesteramides and polyurethanes. The polymeric impact modifier is preferably acrylate ended. The function of the impact modifier is to impart moisture resistance and to increase the flexibility and/or toughness of the acrylic resin composition.

The molecular weight (number average), measured as described herein, of the impact modifier is preferably in the range from 500 to 10,000, more preferably 700 to 5,000, particularly 1,000 to 3,000, and especially 1,500 to 2,500.

The impact modifier preferably has a viscosity, measured as described herein, of less than 200,000, more preferably in the range from 5,000 to 100,000, and especially 10,000 to 50,000 mPa·s.

In a preferred embodiment of the present invention, the impact modifier comprises an oligoester or polyester (hereinafter referred to as a polyester). Polyester is normally produced in a condensation reaction between at least one polycarboxylic acid and at least one polyol. Dicarboxylic acids and diols are preferred. The preferred dicarboxylic acid component of the polyester impact modifier used in the present invention comprises at least one dimer fatty acid, as described above.

The dicarboxylic acid component of the polyester impact modifier may also comprise non-dimeric fatty acids. The non-dimeric fatty acids may be aliphatic or aromatic, and include dicarboxylic acids and the esters, preferably alkyl esters, thereof, preferably linear dicarboxylic acids having terminal carboxyl groups having a carbon chain in the range from 2 to 20, more preferably 6 to 12 carbon atoms, such as adipic acid, glutaric acid, succinic acid, pimelic acid, suberic acid, azelaic acid, sebacic acid, heptane dicarboxylic acid, octane dicarboxylic acid, nonane dicarboxylic acid, decane dicarboxylic acid, undecane dicarboxylic acid, dodecane dicarboxylic acid and higher homologs thereof. Adipic acid is particularly preferred. A monomeric dicarboxylic acid anhydride, such as phthalic anhydride, isophthalic anhydride and terephthalic anhydride may also be employed as the or as part of the non-dimeric fatty acid component.

The polyol component of the polyester is suitably of low molecular weight, preferably in the range from 50 to 650, more preferably 70 to 200, and particularly 100 to 150.

The polyol component may comprise polyols such as pentaerythritol, triols such as glycerol and trimethylolpropane, and preferably diols. Suitable diols include straight chain aliphatic diols such as ethylene glycol, diethylene glycol, 1,3-propylene glycol, dipropylene glycol, 1,4-butylene glycol, 1,6-hexylene glycol, branched diols such as neopentyl glycol, 3-methyl pentane glycol, 1,2-propylene glycol, and cyclic diols such as 1,4-bis(hydroxymethyl)cyclohexane and (1,4-cyclohexane-dimethanol). 1,4-butylene glycol, 1,6-hexylene glycol and neopentyl glycol are preferred, and neopentyl glycol is a particularly preferred diol.

The polyol component may also comprise a dimer fatty diol as described above. The same preferences above for the dimer fatty acid apply to the corresponding dimer fatty diol component of the polyester.

The polyester impact modifier is preferably formed from dicarboxylic acid to diol starting materials at a molar ratio in the range from 1:1.0 to 5.0, more preferably 1:1.2 to 3.0, particularly 1:1.4 to 2.0, and especially 1:1.5 to 1.7. Thus, the diol is preferably present in molar excess so as to obtain a polyester terminated at both ends with OH groups.

The polyester preferably has a molecular weight (number average) in the range from 500 to 3,500, more preferably 1,600 to 2,400, particularly 1,800 to 2,200, and especially 1,900 to 2,100.

The polyester preferably has a glass transition temperature (Tg) in the range from −60 to 0° C., more preferably −50 to −5° C., particularly −40 to −10° C., and especially −35 to −15° C.

The polyester suitably has a hydroxyl value (measured as described herein) in the range from 10 to 100, preferably 20 to 80, more preferably 30 to 70, particularly 35 to 55, and especially 40 to 50 mgKOH/g. In addition, the polyester preferably has an acid value (measured as described herein) of less than 2, more preferably less than 1.5, particularly less than 1.0, and especially less than 0.6.

The impact modifier may also be a copolymer, block, random or graft, of polyester, as defined above, and polyamide. In one embodiment of the invention, the impact modifier is a copolymer, more preferably random, comprising polyester to polyamide present at a ratio in the range from 10 to 95%:5 to 90%, more preferably 40 to 90%:10 to 60%, particularly 60 to 80%:20 to 40%, and especially 67 to 73%:27 to 33% by weight of the copolymer.

Alternatively, the impact modifier may be a polyurethane, for example formed from polyester as defined above, and/or formed by using at least one dimer fatty acid and/or dimer fatty diol as a chain extender.

The impact modifier preferably comprises in the range from 5 to 90%, more preferably 10 to 70%, particularly 15 to 50%, and especially 20 to 30% by weight of residues of dimer fatty acid and/or dimer fatty diol and/or equivalent thereof.

The weight ratio of acrylic resin:impact modifier present in the composition is preferably in the range from 0.2 to 100:1 more preferably 1 to 50:1, particularly 1.5 to 10:1, and especially 2 to 4:1.

In a preferred embodiment of the invention, the impact modifier, preferably polyester, is reacted with an acrylic monomer to form an acrylate ended impact modifier.

Suitable materials which can be used to form acrylate end groups on the impact modifier include acryloyl chloride and methacryloyl chloride, which result in acrylate ended and methacrylate ended impact modifier respectively.

The composition according to the present invention may be in a 2 pack form, and the final composition can be cured by simple mixing of the acrylic resin and impact modifier. The composition preferably comprises a suitable catalyst, such as those known in the art for acrylic resins, for example azoisobutyronitrile or peroxide catalysts such as cumene hydroperoxide, lauryl peroxide, and butanone peroxide. Suitable accelerators may also be employed, for example to speed up the action of the peroxide.

The composition may also comprise, other optional components such as pigments, fillers, for example fumed silica, or silver flake.

Alternatively, the composition may be applied in situ as a free flowing viscous solid, and cured directly by heat or light.

A particular advantage of compositions according to the present invention, is that on curing, phase separation of the impact modifier can occur resulting in the formation of domains or particles of impact modifier within an acrylic resin matrix.

The impact modifier particles are preferably approximately spherical, suitably having a mean aspect ratio d₁:d₂ (where d₁ and d₂, respectively, are the length and width of the particle (measured as described herein)) in the range from 0.5 to 1.5:1, preferably 0.7 to 1.3:1, more preferably 0.8 to 1.2:1, particularly 0.9 to 1.1:1, and especially 0.95 to 1.05:1. In a preferred embodiment of the invention, suitably at least 40%, preferably at least 55%, more preferably at least 70%, particularly at least 80%, and especially at least 90% by number of particles have an aspect ratio within the above preferred ranges given for the mean aspect ratio.

The impact modifier particles preferably have a mean particle diameter (measured as described herein) of less than 500 nm, more preferably in the range from 20 to 400 nm, particularly 50 to 300 nm, and especially 100 to 200 nm.

The size distribution of the impact modifier particles can also have a significant effect on the final properties of, for example, a cured acrylic resin composition according to the present invention. In a preferred embodiment of the invention, suitably at least 50%, preferably at least 60%, more preferably at least 70%, particularly at least 80%, and especially at least 85% by number of particles have a particle diameter within the above preferred ranges given for the mean particle diameter.

In one embodiment, the composition described herein is suitable for use as an adhesive, particularly as a pressure sensitive adhesive, anaerobic adhesive and a reactive hot-melt adhesive. Pressure sensitive adhesives may be used for adhering paper, in particular in stationery applications. Anaerobic adhesives may be used on metals, particularly metal bolts, for example in automotive applications.

In an alternative embodiment, the composition described herein is suitable for use in forming an acrylic sheet, particularly a cast sheet.

In this specification the following test methods have been employed:

(i) Molecular weight number average was determined by Gel Permeation Chromatography (GPC).
(ii) The softening point and glass transition temperature (Tg) were measured by Differential Scanning Calorimetry (DSC) at a scan rate of 20° C./minute using a Mettler DSC30.
(iii) The hydroxyl value is defined as the number of mg of potassium hydroxide equivalent to the hydroxyl content of 1 g of sample, and was measured by acetylation followed by hydrolysation of excess acetic anhydride. The acetic acid formed was subsequently titrated with an ethanolic potassium hydroxide solution.
(iv) The acid value is defined as the number of mg of potassium hydroxide required to neutralise the free fatty acids in 1 g of sample, and was measured by direct titration with a standard potassium hydroxide solution.
(v) Particle size of the impact modifier particles was determined by immersing a cured acrylic sample in liquid nitrogen, preparing thin sections by microtoning, and performing scanning electron microscopy. Photographs were produced at an appropriate magnification, such that about 50 impact modifier particles were displayed in each photograph. A minimum number of 300 particles were sized manually using a transparent size grid. The mean particle diameter, and particle size distribution, of the particles were calculated from the above measurements. In addition, the aspect ratio of the particles was determined from the maximum and minimum dimensions of at least 50 particles. Alternatively, the measurements could be performed by computerised image analysis.
(vi) Viscosity was measured on a Brookfield RV viscometer using spindle 4 at 20 rpm and a temperature of 25° C.
(vii) Mechanical properties or toughness of polymer panels were measured (at a single loading rate and at 23±2° C.) using a linear elastic fracture mechanics (LEFM) analysis. Four material properties were determined namely Gc (fracture toughness in terms of energy), Kc (fracture toughness in terms of strength), σy (yield strength in tension) and E (modulus in flexure). Since for brittle materials, a value for yield strength cannot be directly measured in tension, a value was obtained in compression and then converted to a tensile value by dividing by the plasticity factor 1.3. These four properties are related in a number of ways and either Kc or Gc can be used to monitor toughness. However, Kc on its own is seldom helpful and a useful additional approach in monitoring toughness is to calculate DF (ductility factor) which combines Kc with yield strength and is related to plastic zone size. These terms are defined as follows;

$${G}_{c} = \frac{Δ U}{Δ A}$$

$${K}_{c} = {σ}_{F} {Ya}^{\frac{1}{2}}$$

$$D F = {( \frac{{K}_{c}}{{σ}_{y}} )}^{2}$$

where;
Gc is the critical strain energy release rate in creating new crack area (ΔA),
ΔU is the released energy,
Kc is the critical value of stress field Intensity factor for fracture of a notched specimen with a crack length (a) and fracture stress (σF), and
Y is a geometry function.

The invention is illustrated by the following non-limiting examples.

### EXAMPLE 1

### (a) Preparation of Methacrylated Polyester Impact Modifier

100 g of PRIPLAST 3197 (trade mark, ex Uniqema) (OH ended polyester formed from dimer fatty acid and dimer fatty diol) was placed into a 500 ml reaction vessel equipped with a pressure-equilibrating (PE) dropping funnel, magnetic stirrer, thermocouple, ice-bath and condenser. 400 ml of anhydrous dichloromethane and 13.1 g of triethylamine (25% molar excess) were added and the mixture was thoroughly agitated. 12.6 g of methacryloyl chloride (25% excess), together with 25 ml of anhydrous dichloromethane, were placed into the PE dropping funnel and the flask was placed under nitrogen. The flask was then cooled to 0° C. prior to the dropwise addition of methacryloyl chloride over a period of 30 minutes. The mixture was allowed to reach room temperature and stirring was continued for 24 hours. Two 200 ml portions of the crude reaction mixture were each extracted with 300 ml of saturated solution of sodium bicarbonate, prior to extraction with 300 ml distilled water. The organic layer was then dried over anhydrous magnesium sulphate. The overall yield of product obtained was 98%. Purity was calculated to be approximately 98.5% from ¹H NMR measurements.

### (b) Polymerisation

A monomer mixture was prepared using the following recipe:

30 wt % Methacrylated Polyester produced above (impact modifier)
70 wt % Isobornyl Methacrylate (acrylic monomer)
0.2 wt % Azoisobutyronitrile (AIBN) (catalyst)

Polymer panels of approximately 3 mm in thickness, were prepared by polymerising the monomer mixture between glass plates. The procedure was as follows;

(i) The inside faces of two glass plates (10 cm×10 cm) were covered with release film. (ii) A rubber gasket (4 mm thickness) was placed around the outside edges of one plate and was clipped into place with small fold-back clips. (iii) A small aperture was left in one corner. (iv) The glass plates were then clipped together prior to filling the cavity via the injection of the liquid monomer mixture. (v) The small aperture was then sealed and clipped prior to curing the cell in a water bath at 60° C. for 20 hours. (vi) The bath temperature was then increased to 80° C. and held for 6 hours to complete the polymerisation cycle. (vii) The resulting panels were removed from between the glass plates prior to testing. (viii) The polymer panels were then cut into 5 cm×1 cm test specimens, which were used to determine the mechanical properties of the polymers. The results are shown In Table 1.

### EXAMPLE 2

### Polymerisation

A monomer mixture was prepared using the following recipe:

30 wt % Dimer Diol Diacrylate (made by esterification of acrylic acid and dimer diol) (impact modifier)
70 wt % Isobornyl Methacrylate (acrylic monomer)
0.2 wt % Azoisobutyronitrile (AIBN) (catalyst)

Polymer panels were produced as described in Example 1, the mechanical properties measured and results are shown in Table 1.

### EXAMPLE 3

This is a comparative example not according to the invention.

### Polymerisation

A monomer mixture was prepared using the following recipe:

100 wt % Isobornyl Methacrylate (acrylic monomer)
0.2 wt % Azoisobutyronitrile (AIBN) (catalyst)

Polymer panels were produced as described in Example 1, the mechanical properties measured and results are shown In Table 1.

TABLE 1

| | Kc | Gc | Ductility | σy | E |
|---|---|---|---|---|---|
| Example | (Mpa · m½) @ | (KJ/m²) @ | Factor | (Mpa) @ | (Gpa) @ |
| No | 1 mm · min⁻¹ | 1 mm · min⁻¹ | (mm) | 1 mm · min⁻¹ | 1 mm · min⁻¹ |
| 1 | 0.67 | 0.28 | 0.17 | 51.7 | 1.68 |
| 2 | 0.61 | 0.29 | 0.12 | 53.9 | 1.63 |
| 3 | unable to | unable to | unable to | unable to | unable to |
| (Comp) | measure | measure | measure | measure | measure |

The above experiments illustrate the improved properties of a composition according to the present invention.

1. A composition comprising an acrylic resin and an impact modifier comprising at least one dimer fatty acid and/or dimer fatty diol.

2. A composition according to claim 1 wherein the acrylic resin comprises at least one acrylic monomer.

3. A composition according to claim 2 wherein the acrylic monomer comprises acrylic acid and/or methacrylic acid, and/or esters thereof.

4. A composition according to claim 1 wherein the impact modifier has a molecular weight in the range from 700 to 5,000.

5. A composition according to claim 1 wherein the impact modifier comprises a polyester.

6. A composition according to claim 5 wherein the polyester has a molecular weight in the range from 1,600 to 2,400.

7. A composition according to claim 1 wherein the impact modifier comprises in the range from 10 to 70% by weight of residues of dimer fatty acid and/or dimer fatty diol.

8. A composition according to claim 1 wherein the impact modifier is acrylate ended.

9. A composition according to claim 1 wherein the impact modifier phase separates from the acrylic resin matrix on curing.

10. An adhesive comprising an acrylic resin and an impact modifier comprising at least one dimer fatty acid and/or dimer fatty diol.

11. The use of a composition comprising an acrylic resin and an impact modifier comprising at least one dimer fatty acid and/or dimer fatty diol as an adhesive.

12. A sheet comprising an acrylic resin and an impact modifier comprising at least one dimer fatty acid and/or dimer fatty diol.

13. A sheet according to claim 12 wherein the acrylic resin is polymethyl methacrylate.
